(19) United States
(12) Patent Application Publication
(10) Pub. No.: US 2006/0097979 A1
(43) Pub. Date: May 11, 2006

(54) Back light driving device

(75) Inventors: Kyoung-geun Lee, Suwon-si (KR); Jong-cheol Lee, Seoul (KR); Jung-seob Lee, Busan (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/200,171

(22) Filed: Aug. 10, 2005

(30) Foreign Application Priority Data
Nov. 5, 2004 (KR) 10-2004-0089960

(51) Int. Cl. G09G 3/36

(52) U.S. Cl. 345/102

(57) ABSTRACT

A back light driving device having an inverter circuit connected with a lamp, the inverter circuit including a driving voltage generating unit provided with a plurality of lead parts, which is joined with a power input unit and a switch unit for supplying a driving voltage to the lamp, wherein each of the lead parts includes a plurality of lead terminals. Accordingly, the back light driving device is capable of preventing malfunctions due to disconnections or poor lead terminal junctions of the driving voltage generating unit.

### CROSS-REFERENCE TO RELATED APPLICATIONS

This application claims the benefit under 35 U.S.C. §119(a) of Korean Patent Application No. 10-2004-0089960, filed in the Korean Intellectual Property Office on Nov. 5, 2004, the entire disclosure of which is incorporated herein by reference.

### BACKGROUND OF THE INVENTION

1. Field of the Invention

The present invention relates to a back light driving device. More particularly, the present invention relates to a driving voltage generating unit provided with a plurality of lead terminals.

2. Description of the Related Art

Presently, many display devices such as liquid crystal display (LCD) devices, have small, yet convenient display screens. Such LCD devices may further have a back light device disposed at a rear portion of the display screen to function as a light source.

In Korean Patent Publication No. 10-2004-0009103, the entire disclosure of which is incorporated herein by reference, a back light driving device comprising an inverter connected with a lamp is disclosed. The inverter has therein a driving unit for driving the lamp, a control unit, a transformer, a ballast capacitor, a resistor, and a diode.

The transformer is disposed between the driving unit and the lamp, and the lamp receives a driving signal from the driving unit through the transformer. The driving unit is disposed at a first side of the transformer, and a second side of the transformer is connected with a first electrode of the lamp through the capacitor.

Here, the transformer is soldered on a base plate having only one pair of lead wires. Therefore, if one of the lead wires is poorly soldered, the transformer may malfunction due to a disconnection or a poor lead wire junction.

Accordingly, a need exists for a system and method for providing a back light driving device capable of preventing a malfunction due to a disconnection or a poor lead wire junction of a driving voltage generating unit.

### SUMMARY OF THE INVENTION

Accordingly, it is an aspect of the present invention to solve the above and other problems, and to provide a back light driving device that is capable of preventing a malfunction due to a disconnection or a poor lead wire junction of a driving voltage generating unit.

The foregoing and other aspects of certain exemplary embodiments of the present invention are also achieved by providing a back light driving device comprising an inverter circuit connected with a lamp, wherein the inverter circuit of the back light driving device comprises a driving voltage generating unit provided with a plurality of lead parts, which is joined with a power input unit and switch unit for supplying a driving voltage to the lamp, wherein each of the lead parts comprises a plurality of lead terminals.

According to an embodiment of the present invention, each of the lead parts comprises a main lead terminal connected to the driving voltage generating unit and a sub lead terminal diverged from the main lead terminal.

According to an embodiment of the present invention, the driving voltage generating unit comprises a transformer.

### BRIEF DESCRIPTION OF THE DRAWINGS

The above and other aspects and advantages of the present invention will become apparent and more readily appreciated from the following description of the exemplary embodiments, taken in conjunction with the accompanying drawings, of which:

FIG. 1 is a perspective view of a driving voltage generating unit according to an embodiment of the present invention;

FIG. 2 is a schematic view showing an inside arrangement of a driving voltage generating unit according to an embodiment of the present invention; and

FIG. 3 is a schematic block diagram of an inverter circuit according to an embodiment of the present invention.

Throughout the drawings, like reference numerals will be understood to refer to like parts, components and structures.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

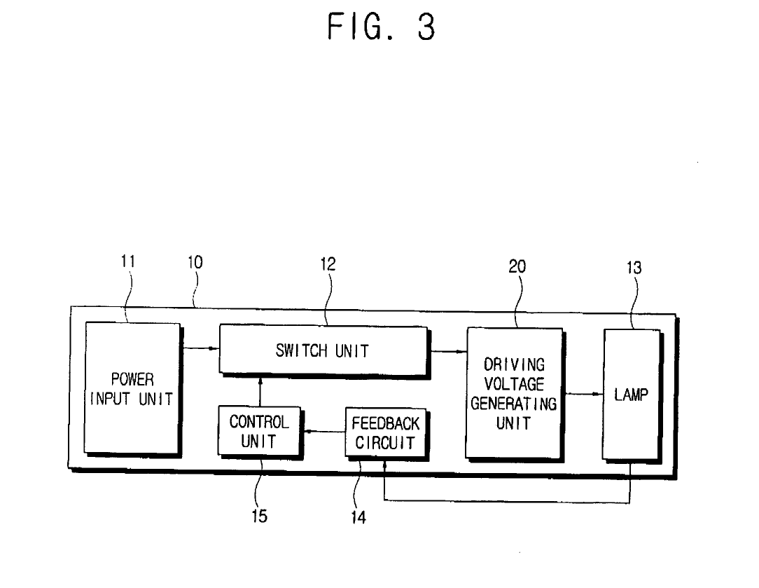

As shown in FIG. 3, a back light driving device according to an embodiment of the present invention comprises an inverter circuit 10 connected with a lamp 13. The inverter circuit 10 may comprise a power input unit 11, a switch unit 12, a driving voltage generating unit 20, a feedback circuit 14, and a control unit 15.

An input signal of the power input unit 11 is switched by the switch unit 12 and is provided to the lamp 13 through the driving voltage generating unit 20. The feedback circuit 14 detects an electric current from the lamp 13, compares the electric current with a reference current, and provides a signal to the control unit 15. The control unit 15 controls the switch unit 12 according to the signal from the feedback circuit 14.

The driving voltage generating unit 20 may comprise a transformer which converts an input voltage (for example, DC 14V) supplied from the power input unit 11 into a high alternating voltage and supplies the lamp 13 with the high alternating voltage.

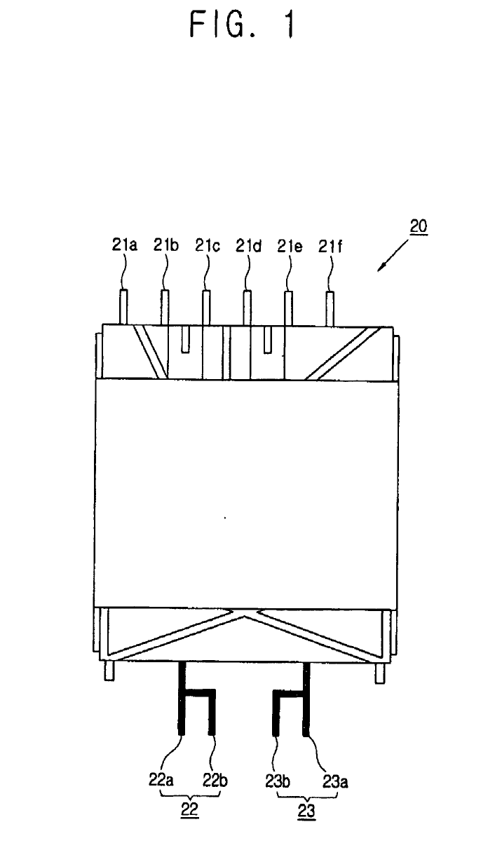

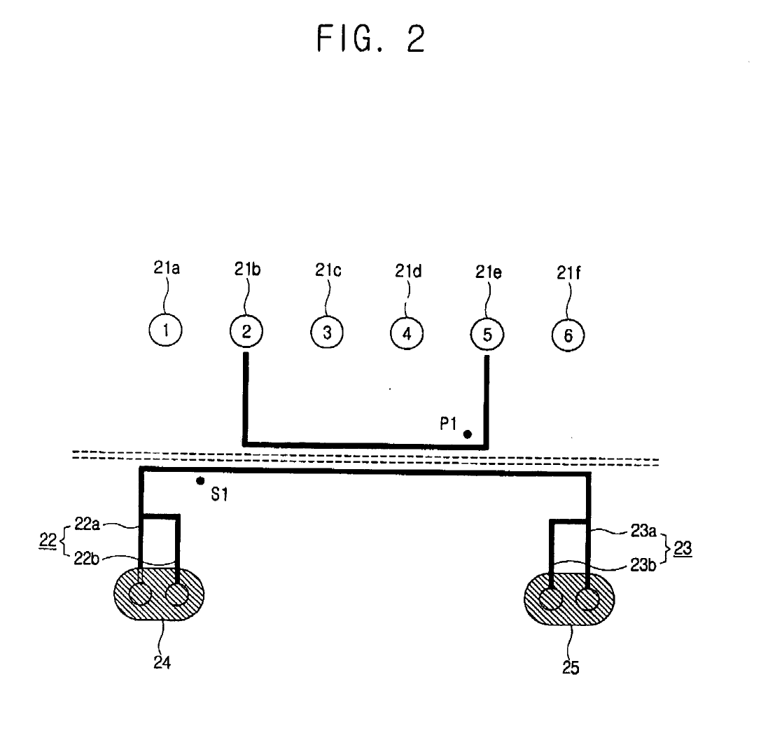

As shown FIG. 1, the driving voltage generating unit 20 has therein a plurality of pins 21a to 21f, and first and second lead parts 22 and 23. As shown in FIGS. 2 and 3, a first side of the driving voltage generating unit 20 is connected with the voltage input unit 11 through the switch unit 12, and a second side of the driving voltage generating unit 20 is connected with an electrode (not shown) of the lamp 13.

By joining the first lead part 22 to the inverter circuit 10, a first junction 24 is formed. Also, by joining the second lead part 23 to the inverter circuit 10, a second junction 25 is formed.

The first lead part 22 comprises a first main lead terminal 22a connected to the driving voltage generating unit 20, and a first sub lead terminal 22b diverged from the first main lead terminal 22a. The second lead part 23 comprises a second main lead terminal 23a connected to the driving voltage generating unit 20, and a second sub lead terminal 23b diverged from the second main lead terminal 23a.

Accordingly, even though one of the first main and sub lead terminals 22a and 22b may be poorly joined or becomes disconnected from the inverter circuit 10 or the driving voltage generating unit 20, the back light driving device can function normally via the other terminal. Furthermore, heat generation and sparking due to the poor junction can be prevented. In like fashion, even though one of the second main and sub lead terminals 23a and 23b may be poorly joined or becomes disconnected, the back light driving device can function normally via the other terminal. As with the first main and sub lead terminals, heat generation and sparking due to the poor junction can be prevented.

An operating process of the back light driving device according to the above exemplary configuration will now be described in greater detail.

Returning to FIG. 3, the input signal of the power source input unit 11 is switched by the switch unit 12 and is provided to the lamp 13 through the driving voltage generating unit 20. The feedback circuit 14 detects the electric current from the lamp 13, compares the electric current with the reference electric current, and provides the control unit 15 with the signal. The control unit 15 controls the switch unit 12 according to the signal from the feedback circuit 14.

Here, the first main and sub lead terminals 22a and 22b of the driving voltage generating unit 20 are joined with the inverter circuit 10, and the second main and sub lead terminals 23a and 23b of the driving voltage generating unit 20 are joined with the inverter circuit 10. Therefore, even though one of the first main and sub lead terminals 22a and 22b may be poorly joined or becomes disconnected, the back light driving device can function normally via the other terminal. Also, even though one of the second main and sub lead terminals 23a and 23b may be poorly joined or becomes disconnected, the back light driving device can function normally via the other terminal. Furthermore, heat generation and sparking due to the poor junction can be prevented in each case.

As described in the above exemplary embodiments, each lead part 22 and 23 of the driving voltage generating unit 20 is provided with a plurality of lead terminals 22a, 22b, 23a, and 23b, so that even though any one of the lead terminals may be poorly joined or becomes disconnected, the driving voltage generating unit can function normally. Consequently, the operation reliability of the back light driving device can be enhanced, and also heat generation and sparking due to the poor junction can be prevented.

Although only a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A back light driving device comprising an inverter circuit connected with a lamp, the inverter circuit of the back light driving device comprising:
a driving voltage generating unit provided with a plurality of lead parts for supplying a driving voltage to the lamp, wherein each of the lead parts comprises a plurality of lead terminals.

2. The back light driving device of claim 1, wherein the plurality of lead terminals of each of the lead parts comprises:
a main lead terminal connected to the driving voltage generating unit; and
at least a sub lead terminal connected to the driving voltage generating unit and diverged from the main lead terminal.

3. The back light driving device of claim 1, wherein the driving voltage generating unit comprises a transformer.

4. The back light driving device of claim 2, wherein the driving voltage generating unit comprises a transformer.

5. A driving voltage generating unit, comprising:
a transformer; and
a plurality of lead parts electrically coupled to the transformer, wherein each of the lead parts comprises a plurality of lead terminals.

6. The driving voltage generating unit of claim 5, wherein the plurality of lead terminals of each of the lead parts comprises:
a main lead terminal electrically coupled to the transformer; and
at least a sub lead terminal electrically coupled to the transformer and diverged from the main lead terminal.

7. A method for electrically coupling a driving voltage generating unit, comprising the steps of:
providing a plurality of lead parts electrically coupled to the driving voltage generating unit, wherein each of the lead parts comprises a plurality of lead terminals;
electrically coupling a main lead terminal of said plurality of lead terminals to form a first junction; and
electrically coupling at least a sub lead terminal of said plurality of lead terminals to form a second junction, wherein the sub lead terminal is diverged from the main lead terminal to form a parallel circuit.
